(19) United States
(12) Patent Application Publication
(10) Pub. No.: US 2016/0357762 A1
(43) Pub. Date: Dec. 8, 2016

(54) Smart View Selection In A Cloud Video Service

(71) Applicant: Pelco, Inc., Clovis, CA (US)

(72) Inventors: Farzin Aghdasi, Clovis, CA (US); Tony T. DiCroce, Fresno, CA (US); Scott M. Rippee, Clovis, CA (US); Barry Velasquez, Clovis, CA (US); Emil Andersen, III, Clovis, CA (US); Greg M. Millar, Coarsegold, CA (US); Kirsten A. Medhurst, Fairfax, VA (US); Stephen J. Mitchell, Reedley, CA (US)

(21) Appl. No.: 15/105,881

(22) PCT Filed: Dec. 23, 2013
(86) PCT No.: PCT/US13/77574

§ 371 Date: Jun. 17, 2016

(51) Int. Cl. G06F 17/30; H04N 5/247; H04N 7/18

(52) U.S. Cl. CPC G06F 17/3082; H04N 7/181; H04N 5/247; G06F 17/30858; H04L 67/12

(57) ABSTRACT

A cloud-based network service provides intelligent access to surveillance camera views across multiple locations and environments. A cloud computing server maintains a database of the views captured by the cameras connected to the network. The database is indexed by one or more classes according to tags characterizing the views obtained by each camera. In response to a user search string, the string is robustly interpreted against the classes and other indicators to search the database and determine a selection of views. The server causes the selection of views to be transmitted to a user interface, where a user can remotely monitor an environment through the selected views.

### BACKGROUND OF THE INVENTION

Surveillance cameras are commonly used to monitor indoor and outdoor locations. Networks of surveillance cameras may be used to monitor a given area, such as the internal and external portion of a retail establishment. Cameras within a surveillance camera network are typically not aware of their location within the system or the existence and locations of other cameras in the system. Thus, a user monitoring video feeds produced by the cameras, such as a retail store manager, must manually analyze and process the video feeds to track and locate objects within the monitored areas. Conventional camera networks operate as a closed system, in which networked security cameras provide video feeds for a single geographic area, and a user observes the video feeds and operates the network from a fixed-location user terminal located at the same geographic area.

In other implementations, a network of surveillance cameras may extend across a number of remote locations and is connected by a wide area network, such as the Internet. Such a network is used to monitor several areas remote from one another. For example, a network of cameras may be used to provide video feeds of a number of retail establishments under common management.

### SUMMARY OF THE INVENTION

Example embodiments of the present invention provide a method of managing a video surveillance system. A plurality of entries are stored to a database, where each entry corresponds to one of a plurality of cameras. Further, each entry includes a camera identifier and at least one tag. The database is indexed by one or more classes, and each of the entries is associated with the one or more of the classes based on its tag. The database is then searched, based on a user input string and the classes, to determine a selection of the entries. As a result of the search, video content is caused to be transmitted to a user interface, where the video content corresponds to at least one of the plurality of cameras corresponding to the selection of entries. The cameras may be connected to distinct nodes of a network, and the video content may be routed across the network to the user interface.

In further embodiments, the plurality of entries can be associated with the classes based on a semantic equivalence of the respective tags. The tags may be automatically updated in response to a user operation, such as accessing a camera, viewing the video content, and selecting at least one camera. The updating can include, for example, automatically adding a tag to the entries, the tag corresponding to a user input.

In still further embodiments, the tags may be automatically updated based on a camera identifier or a set of rules. For example, a tag may be added to indicate a view obtained by a respective camera. Tags may also be modified to match a semantically equivalent tag.

In yet further embodiments, a semantic equivalent of the user input string may be generated and employed in the database search. The classes may include a number of classes that indicate characteristics of the associated cameras, such as the view obtained by the camera or geographic location of the camera. A camera, based on its tags, may be associated with one or more of the classes. To accommodate additional organization of the cameras, classes may be generated automatically responsive to the tags.

Further embodiments of the invention provide a system for managing a video surveillance system, the system including a database, a database controller and a network server. The database stores a number of entries, each entry corresponding to a respective camera. Each entry may include a camera identifier and one or more tags. The database controller operates to index the database by one or more classes, each of the entries being associated with one or more of the classes based on the tags. The database controller also searches the database, based on a user input string and the classes, to determine a selection of the entries. The network server causes video content to be transmitted to a user interface, the video content corresponding the cameras associated with the selection of entries.

Further embodiments of the invention provide a method of managing a video surveillance system. Motion data corresponding to recorded video content from at least one of a plurality of cameras is defined. A plurality of entries are stored to a database, where each entry includes time data indicating start and stop times of a respective time period of interest. At least one video segment is generated from the recorded video content. Each video segment has time boundaries based on the motion data and the time data of at least one of the entries. The video segment can then be transmitted to a user interface for playback.

In still further embodiments, the defining, storing, generating and causing can be performed by a cloud-based server, and the cameras can be connected to distinct nodes of a network in communication with the cloud-based video server. Selection of the at least one video segment based on the nodes can be enabled at the user interface. To form a video segment, recorded video from a number of different cameras may be combined. The entries may include one or more tags indicating the respective time period of interest, the motion data, and the time boundaries.

In yet further embodiments, in generating the video segment, a selection of the video content may be excluded, even when that selection is within the start and stop times defined by an entry, if the selection exhibits less than a threshold of motion as indicated by the motion data. Likewise, a selection of the video content may be included when it has greater than a threshold of motion indicated by the motion data.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a simplified illustration of a retail scene and network in which an embodiment of the invention may be implemented.

FIG. 2 is a block diagram of a network in which an embodiment of the invention may be implemented.

FIG. 3 is a block diagram of a cloud computing server in one embodiment.

FIG. 4 is a block diagram illustrating example database entries in one embodiment.

FIG. 5 is an illustration of a user interface provided by a cloud-based monitoring service in an example embodiment.

FIG. 6 is a flow diagram of a method of managing views of a video surveillance network in one embodiment.

FIG. 7 is a flow diagram of a method of managing recorded video shifts (i.e., time periods of interest) of a video surveillance network in one embodiment.

FIG. 8 is a block diagram of a computer system in which embodiments of the present invention may be implemented.

### DETAILED DESCRIPTION OF THE INVENTION

A description of example embodiments of the invention follows. The teachings of all patents, published applications and references cited herein are incorporated by reference in their entirety.

A typical surveillance camera network employs a number of cameras connected to a fixed, local network that is limited to a single area to be monitored. Such a network faces a number of limitations. For example, the network does not provide mobility of video; video content and associated data are available only at an on-site user interface, which is typically physically located in a local control room within the same site at which the cameras are deployed. Further, the camera network operates as an insular system and is not configured to receive or utilize video content or other information corresponding to entities outside the local camera network. Within the camera network, the user interface may also not be capable of performing analytics for information associated with multiple cameras; instead, the interface may only enable an operator of the camera network to manually inspect and analyze data associated with multiple cameras.

To increase the mobility and versatility of a video surveillance network and mitigate at least the shortcomings stated above, a video surveillance network can be designed using a multi-tiered structure to leverage cloud-based analysis and management services for enhanced functionality and mobility. Cloud-based services refers to computing services that are provided by and accessed from a network service provider via cloud computing. A multi-tiered network providing cloud-based services is described in U.S. patent application Ser. No. 13/335,591, the entirety of which is incorporated herein by reference.

Such a multi-tiered surveillance network can be implemented to monitor several different environments simultaneously, such as a number of retail establishments under common management. The manager may be able to access and monitor scenes from all such establishments simultaneously from a single interface. However, monitoring several environments at once may present additional challenges to both the manager and to the surveillance network. For example, if a single manager is responsible for monitoring operations at many geographically distributed locations, his/her attention and availability for monitoring each store may be substantially limited. Further, the bandwidth at the manager's interface may be limited, preventing immediate access to all video content. In view of these limitations, it is beneficial to organize, search and present the video content of the surveillance network in an intelligent manner that aids the manager in quickly and easily accessing both instant and recorded video content that is most relevant and noteworthy.

Example embodiments of the invention address the limitations described above by providing an intelligent cloud-based service for managing a video surveillance system. In one embodiment, a cloud computing server provides a number of services for intelligently processing video content from several cameras across a network and providing selective, organized video content to a cloud-connected user interface.

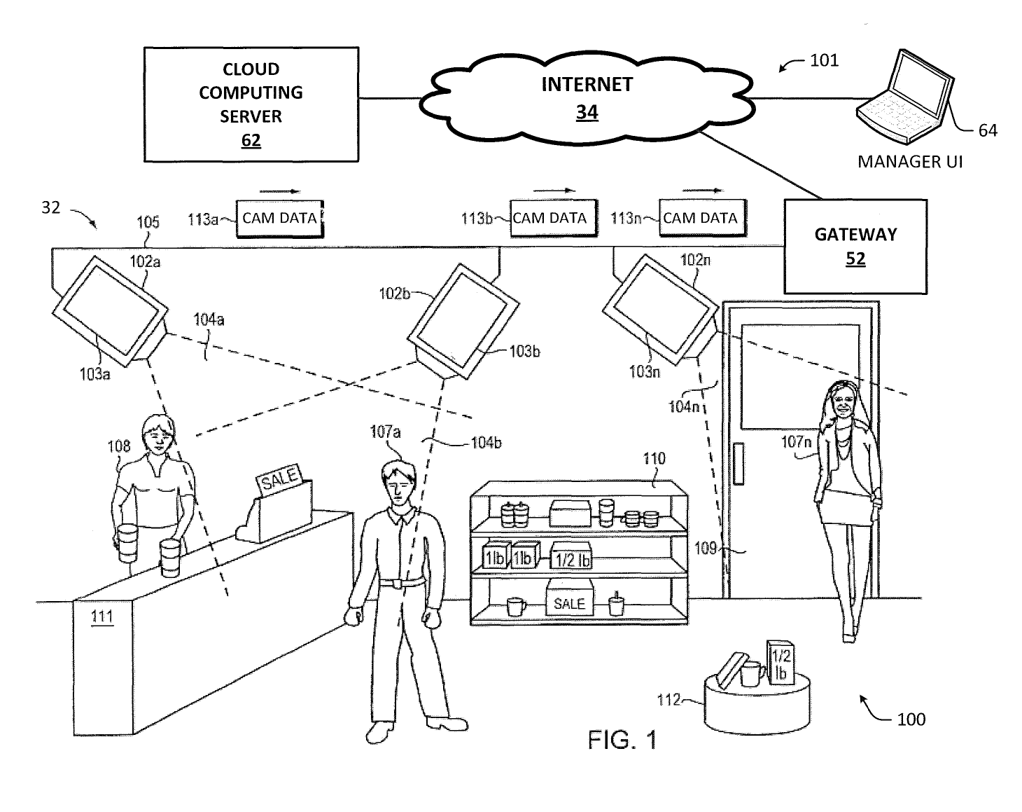

FIG. 1 is a simplified illustration of a retail scene 100 and network 101 in which an embodiment of the present invention may be implemented. The retail scene 100 illustrates a typical retail environment in which consumers may do business. A retail establishment typically is overseen by a manager, who is responsible for day-to-day operations of the store, including the actions of its employees. The retail scene 100 with the entrance 109 further includes a cash register area 111. The cash register area 111 may be stationed by an employee 108. The employee 108 likely interacts with the customers 107a-n at the cash register area 111. The retail scene 100 further includes typical product placement areas 110 and 112 where customers 107a-n may browse products and select products for purchase.

The scene 100 further includes cameras 102a-n, which may include stationary cameras, pan-tilt-zoom (PTZ) cameras, or any other camera appropriate to monitor areas of interest within the scene. The scene 100 may include any number of cameras 102a-n as necessary to monitor areas of the scene of interest, including areas inside and outside of the retail establishment. The cameras 102a-n have respective fields of view 104a-n. These cameras 102a-n may be oriented such that the respective fields of view 104a-n are in down-forward orientations such that the cameras 102a-n may capture the head and shoulder area of customers 107a-n and employee 108. The cameras 102a-n may be positioned at an angle sufficient to allow the camera to capture video content of each respective area of interest. Each of the cameras may further include a processor 103a-n, which may be configured to provide a number of functions. In particular, the camera processors 103a-n may perform image processing on the video, such as motion detection, and may operate as a network node to communicate with other nodes of the network 101 as described in further detail below. In further embodiments, the cameras 102a-n may be configured to provide people detection as described in U.S. patent application Ser. No. 13/839,410, the entirety of which is incorporated herein by reference.

The cameras 102a-n may be connected via an interconnect 105 (or, alternatively, via wireless communications) to a local area network (LAN) 32, which may encompass all nodes of the retail establishment. The interconnect 105 may be implemented using any variety of techniques known in the art, such as via Ethernet cabling. Further, while the cameras 102a-n are illustrated as interconnected via the interconnect 105, embodiments of the invention provide for cameras 102a-n that are not interconnected to one another. In other embodiments of the invention, the cameras 102a-n may be wireless cameras that communicate with the metric server 106 via a wireless network.

The gateway 52 may be a network node, such as a router or server, that links the cameras 102a-n of the LAN 32 to other nodes of the network 101, including a cloud computing server 62 and a manager user interface (UI) 64. The cameras 102a-n collect and transmit camera data 113a-n, which may include video content, metadata and commands, to the gateway 52, which, in turn, routes the camera data 113a-n to the cloud computing server 62 across the Internet 34. A user, such as a manager of the retail establishment, may then access the manager UI 64 to access the camera data selectively to monitor operations at the retail scene 100. Because the manager UI 64 accesses the camera data 113a-n via a cloud-based service connected to the Internet 34, the manager may therefore monitor operations at the retail scene from any location accessible to the Iinternet 34.

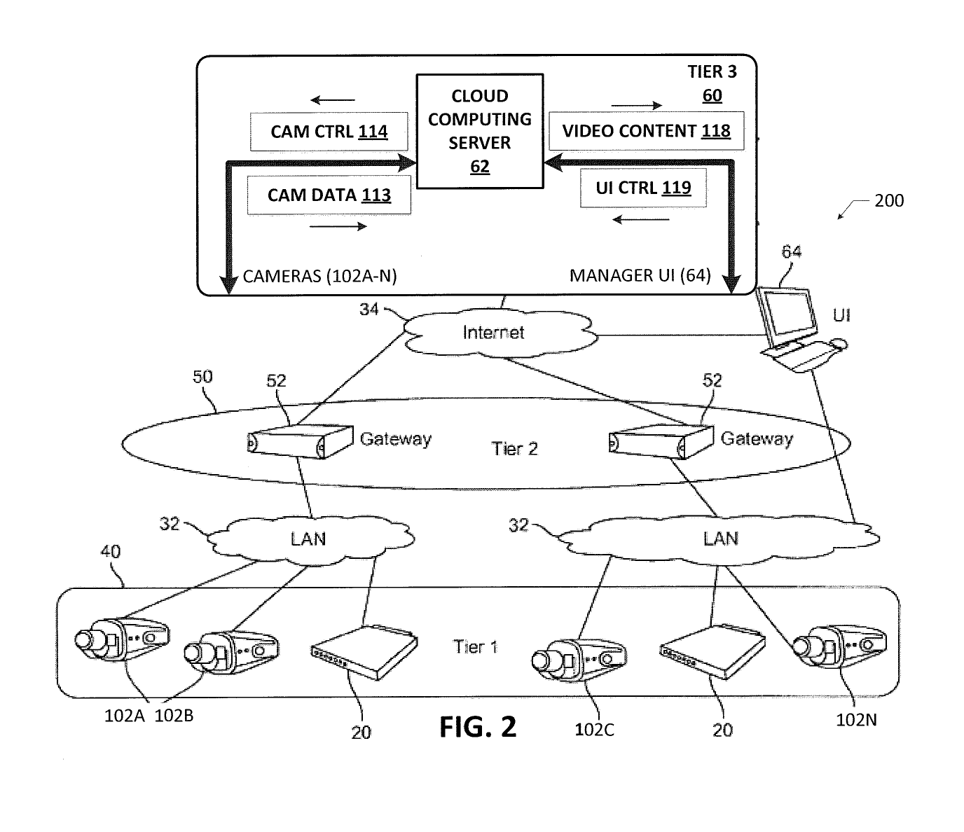

In further embodiments, however, the retail scene 100 may be only one establishment of several (not shown) for which a manager is responsible. The manager may be able to access and monitor all such retail scenes simultaneously from the manager UI 64. A further embodiment of the invention, encompassing a number of different monitored environments, is described below with reference to FIG. 2.

FIG. 2 illustrates an example of a cloud-based network system 200 for video surveillance system management. A first tier 40 of the system includes edge devices, such as routers 20 and cameras 102a-n, with embedded video analytics capability. The first tier 40 of the system connects to a second tier 50 of the system through one or more LANs 32. The second tier 50 includes one or more gateway devices 52 that may operate as described above with reference to FIG. 1. The second tier 50 of the system connects via the Internet 34 to a third tier 60 of the system, which includes cloud computing services provided via a cloud computing server 62 and/or other entities. Further, a user interface 64, which may be configured as described above with reference to FIG. 1, can access information associated with the system 200 via the LAN(s) 32 and/or the Internet 34. In particular, the user interface 64 may connect to the cloud computing 62, which can provide monitoring and management services as described below. The user interface 64 may include, for example, a computer workstation or a mobile computing device such as a smartphone or a tablet computer, and provides a visual interface and functional modules to enable an operator to query, process and view data associated with the system in an intelligent and organized manner. As the system 200 is cloud-based and operates via the Internet 34, the user interface 64 may connect to the system 200 from any location having Internet access, and thus may be located in any suitable location and need not be co-located with any particular edge device(s) or gateway(s) associated with the system.

The system 200 may be configured to monitor a plurality of independent environments that are remote from one another. For example, the LAN(s) 32 may each be located at a different retail or other establishment that falls under common management (e.g., several franchises of a consumer business), and thus are to be monitored by a common manager or group of managers. The manager may be able to access and monitor scenes from all such establishments simultaneously from the manager UI 64. However, monitoring several environments at once may present additional challenges to both the manager and to the system 200. For example, if a single manager is responsible for monitoring operations at many geographically distributed locations, his/her attention and availability for monitoring each store may be substantially limited. Further, the bandwidth at the manager interface 64 may be limited, preventing immediate access to all video content. Bandwidth limitations can derive from the limitations a mobile network used by a manager who must frequently access mobile video while traveling, or can derive from sharing bandwidth with other business services. Additional challenges are present at the user interface. For example, the manager may not possess the technical expertise to access the video content of several stores efficiently. The option to access many different cameras can make it difficult for a manager to organize and recall the views provided by each camera. Organizing the camera views at the user interface can be difficult, leading to errors and inconsistencies across the different views.

Previous solutions to the aforementioned challenges include limiting bandwidth usage and modifying operation to increase retention time. To limit bandwidth, mobile access may be disabled or restricted, access can be limited to one store at a time, the number of active users and number of accessible cameras can be limited for a given time, and the quality of the video content can be degraded. To increase retention time of the service, all video content may be pushed to the cloud, the image quality or frame rate of the video content may be reduced, and recording of the video may be controlled to occur only upon detection of motion. These solutions typically result in suboptimal monitoring service, and yet still fail to adequately address all of the challenges described above that are present in a cloud-based service monitoring several different environments.

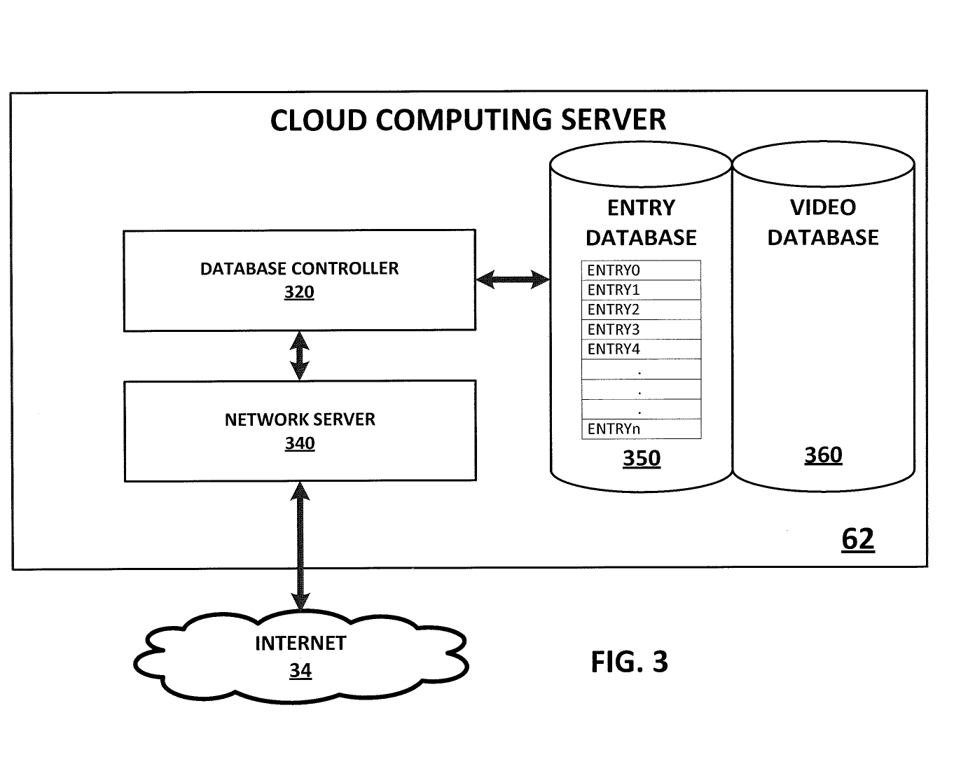

Example embodiments of the invention address the limitations described above by providing an intelligent cloud-based service for managing a video surveillance system. In one embodiment, referring again to FIG. 2, a cloud computing server 62 provides a number of services for intelligently processing video content from several cameras 102a-n across the network 200 and providing selective, organized video content to a cloud-connected user interface 64. The cloud computing server 62 communicates with the cameras 102a-n to collect camera data 113, and may send control signals 114 to operate the cameras 102a-n (e.g., movement of a PTZ camera and enabling/disabling recording). Likewise, the cloud computing server 62 communicates with the user interface to provide live video streams and pre-recorded video content 118, and is responsive to UI control signals 119 to determine the video content to be presented and to update a database at the server 62. Operation of the cloud computing server is described in further detail below with reference to FIGS. 3-7.

In further embodiments, the network system 200 may be configured to perform additional operations and provide additional services to a user, such as additional video analysis and related notifications. Examples of such features are described in further detail in U.S. patent application Ser. No. 13/335,591, the entirety of which is incorporated herein by reference. For example, the cameras 102a-n may be configured to operate a video analytics process, which may be utilized as a scene analyzer to detect and track objects in the scene and generate metadata to describe the objects and their events. The scene analyzer may operate as a background, subtraction-based processing, and may describe an object with its color, location in the scene, time stamp, velocity, size, moving direction, etc. The scene analyzer may also trigger predefined metadata events such as zone or tripwire violation, counting, camera sabotage, object merging, object splitting, still objects, object loitering, etc. Object and event metadata, along with any other metadata generated by the edge device(s), can be sent to the gateway 52, which may store and process the metadata before forwarding processed metadata to the cloud computing server 62. Alternatively, the gateway may forward the metadata directly to the cloud computing server 62 without initial processing.

In an embodiment implementing metadata generation as described above, the gateway 52 may be configured as a storage and processing device in the local network to store video and metadata content. The gateway 52 can be wholly or in part implemented as a network video recorder or an independent server. As stated above, metadata generated from edge devices are provided to their corresponding gateway 52. In turn, the gateway 52 may upload video captured from the cameras 102a-n to the cloud computing server 62 for storage, display, and search. Because the volume of the video captured by the cameras 102a-n may be significantly large, it may be prohibitively expensive in terms of cost and bandwidth to upload all the video content associated with the cameras 102a-n. Thus, the gateway 52 may be utilized to reduce the amount of video sent to the cloud computing server 62. As a result of metadata filtering and other operations, the amount of information sent to the cloud computing server 62 from the gateway 52 can be reduced significantly (e.g., to a few percent of the information that would be sent to the cloud computing server 62 if the system sent all information continuously). In addition to cost and bandwidth savings, this reduction improves the scalability of the system, enabling a common platform for monitoring and analyzing surveillance networks across a large number of geographic areas from a single computing system 64 via the cloud computing server 62.

The metadata provided by the edge devices is processed at the gateway 52 to remove noise and reduce duplicated objects. Key frames of video content obtained from the edge devices can also be extracted based on metadata time stamps and/or other information associated with the video and stored as still pictures for post-processing. The recorded video and still pictures can be further analyzed to extract information that is not obtained from the edge devices using enhanced video analytics algorithms on the gateway 52. For example, algorithms such as face detection/recognition and license plate recognition can be executed at the gateway 52 to extract information based on motion detection results from the associated cameras 102a-n. An enhanced scene analyzer can also be run at the gateway 52, which can be used to process high definition video content to extract better object features.

By filtering noisy metadata, the gateway 52 can reduce the amount of data uploaded to the cloud computing servers 62. Conversely, if the scene analyzer at the gateway 52 is not configured correctly, it is possible that many noises will be detected as objects and sent out as metadata. For instance, foliage, flags and some shadows and glares can generate false objects at the edge devices, and it is conventionally difficult for these edge devices to detect and remove such kinds of noise in real time. However, the gateway 52 can leverage temporal and spatial information across all cameras 102a-n and/or other edge devices in the local surveillance network to filter these noise objects with less difficulty. Noise filtering can be implemented at an object level based on various criteria. For instance, an object can be classified as noise if it disappears soon after it appears, if it changes moving direction, size, and/or moving speed, if it suddenly appears and then stands still, etc. If two cameras have an overlapped area and they are registered to each other (e.g., via a common map), an object identified on one camera can also be identified as noise if it cannot be found at the surrounding area of the location on the other camera. Other criteria may also be used. Detection of noise metadata as performed above can be based on predefined thresholds; for example, an object can be classified as noise if it disappears within a threshold amount of time from its appearance or if it exhibits more than a threshold change to direction, size and/or speed.

By classifying objects as noise as described above, the gateway 52 is able to filter out most of the false motion information provided by the edge devices before it is sent to the cloud. For instance, the system can register cameras 102a-n on a map via a perspective transformation at the gateway 52, and the feature points of the scene can be registered with the corresponding points on the map. This approach enables the system to function as a cross-camera surveillance monitoring system. Since objects can be detected from multiple cameras 102a-n in the areas at which the cameras 102a-n overlap, it is possible to use this information to remove noise from metadata objects.

As another example, the gateway 52 can leverage temporal relationships between objects in a scene monitored by edge devices to facilitate consistency in object detection and reduce false positives. Referring again to the example of a camera observing a parking lot, an edge device may generate metadata corresponding to a person walking through the parking lot. If the full body of the person is visible at the camera, the camera generates metadata corresponding to the height of the person. If subsequently, however, the person walks between rows of cars in the parking lot such that his lower body is obscured from the camera, the camera will generate new metadata corresponding to the height of only the visible portion of the person. As the gateway 52 can intelligently analyze the objects observed by the camera, the gateway 52 can leverage temporal relationships between observed objects and pre-established rules for permanence and feature continuity to track an object even if various portions of the object become obscured.

After filtering noisy metadata objects and performing enhanced video analytics as described above, the remaining metadata objects and associated video content are uploaded by the gateway 52 to a cloud computing service. As a result of the processing at the gateway 52, only video clips associated with metadata will be uploaded to the cloud. This can significantly reduce (e.g., by 90% or more) the amount of data to be transmitted. The raw video and metadata processed by the gateway 52 may also be locally stored at the gateway 52 as backup. The gateway 52 may also transmit representations of video content and/or metadata to the cloud service in place of, or in addition to, the content or metadata themselves. For instance, to reduce further the amount of information transmitted from the gateway 52 to the cloud corresponding to a tracked object, the gateway 52 may transmit coordinates or a map representation of the object (e.g., an avatar or other marking corresponding to a map) in place of the actual video content and/or metadata.

The video uploaded to the cloud computing server 62 can be transcoded with a lower resolution and/or frame rate to reduce video bandwidth on the Internet 34 for a large camera network. For instance, the gateway 52 can convert high-definition video coded in a video compression standard to a low-bandwidth video format in order to reduce the amount of data uploaded to the cloud.

By utilizing the cloud computing service, users associated with the system can watch and search video associated with the system anywhere at any time via a user interface provided at any suitable fixed or portable computing device 64. The user interface can be web-based (e.g., implemented via HTML 5, Flash, Java, etc.) and implemented via a web browser, or, alternatively, the user interface can be provided as a dedicated application on one or more computing platforms. The computing device 64 may be a desktop or laptop computer, tablet computer, smartphone, personal digital assistant (PDA) and/or any other suitable device.

Additionally, use of cloud computing services provided enhanced scalability to the system. For instance, the system can be utilized to integrate a wide network of surveillance systems corresponding to, for example, different physical branches of a corporate entity. The system enables a user at a single computing device 64 to watch and search video being uploaded to the cloud service from any of the associated locations. Further, if a system operator desires to search a large amount of cameras over a long period of time, the cloud service can execute the search on a cluster of computers in parallel to speed up the search. The cloud computing server 62 can also be operable to provide a wide range of services such as a forensic search service efficiently, operational video service, real-time detection service, camera network service, or the like.

FIG. 3 is a block diagram of a cloud computing server 62 in one embodiment, and may include features as described above with reference to FIGS. 1 and 2. The cloud computing server 62 is illustrated in simplified form to convey an embodiment of the present invention, and may include additional components as understood in the art. The cloud computing server includes a network server 340, which may be configured to communicate with the cameras, gateways, user interface and other cloud network components across the Internet 34 as described above. The network server 340 may also operate a cloud-based software service for accessing the video content and other information related to the environments connected to the cloud network. This software service can be accessed, for example, by a user interface across the Internet 34.

The cloud computing server 62 further includes a database controller 320, an entry database 350, and a video database 360. The network server 340 communicates with the database controller 320 to forward video content for storage at the video database 360, as well as to access and modify stored video content at the video database 360 (e.g., responsive to commands from a user interface). In some instances, the network server 340 may also communicate with the database controller 350 to modify entries of the entry database 350. The database controller 320 generally manages the content stored at the video database 360, which may store raw or processed video content uploaded from the surveillance cameras, as well as accompanying metadata.

The database controller 320 also manages the entries stored at the entry database 350. The entry database 350 may store one or more tables holding a number of entries, which are utilized by the database controller 320 and network server 340 to organize video content and determine a selection of video content to provide to a user interface.

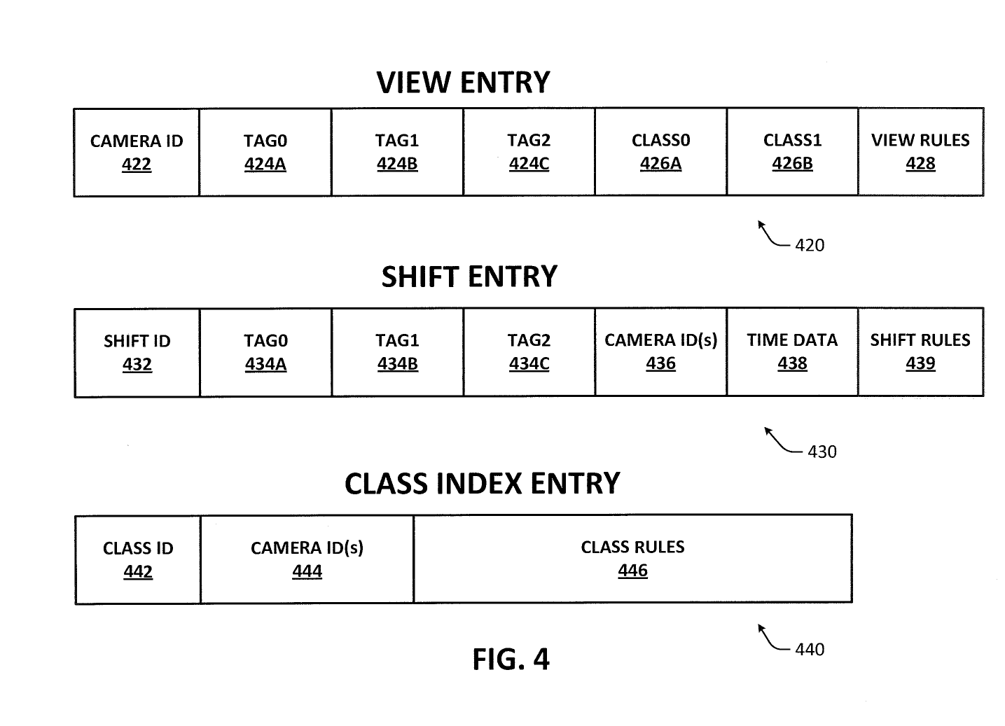

The entries of the entry database can take a number of different forms to facilitate different functions within the cloud-based service. For example, a subset of entries can define respective “views” obtained by the cameras, enabling the cameras to be organized and efficiently accessed at the user interface. Another subset of entries can define respective “classes,” which can be used to further organize and characterize the views. Further, another subset of entries can define “shifts,” or time periods of interest to a manager, and can be used to define recorded video for playback at the user interface. Example entries are described in further detail below with reference to FIG. 4.

FIG. 4 is a block diagram illustrating example database entries in one embodiment, including a view entry 420, a shift entry 430, and a class entry 440. The view entry 420 may define and describe the view obtained by a given camera. Each surveillance camera in a network may have a corresponding view entry. Each view entry may include the following: a camera ID 422 holds a unique identifier for the respective camera and may be coded to indicate the geographic location of the camera or a group (e.g., a particular retail store or other environment) to which the camera belongs. Tags 424A-C can be utilized to indicate various information about the respective camera, such as the view obtained by the camera (e.g., point of sale, front door, back door, storage room), the geographic location of the camera, or the specific environment (e.g., a given retail establishment) occupied by the camera. The tags 424A-C may also hold user-defined indicators, such as a bookmark or a frequently-accessed or “favorite” status. Classes 426A-B indicate one or more classes to which the view belongs. The classes 426A-B may correspond to the class ID of a class entry 440, described below. The view entry 420 may also contain rules 428 or instructions for indicating alerts related to the view, as described below.

The class entry 440 may define and describe a class of views, which can be used to characterize and organize the camera views further. Each class entry may include the following: a class ID 442 holds a unique identifier for the respective class, which may also include a label or descriptor for display and selection at a user interface. The camera ID(s) 444 hold the camera IDs of the one or more views associated with the class. The camera ID(s) 444 of the class entry 440 and the classes 426A-B of the view entry 420 may provide the same use of associating views with classes, and thus an embodiment may employ only one of the camera ID(s) 444 and classes 426A-B. The class rules 446 can define a number of conditions under which a view is added to the class. For example, the class rules 446 may reference a number of tags that are matched against the tags of each view entry (including, optionally, semantic equivalents of the tags) to determine whether each entry should be included in or excluded from a class. Each class may define any group of entries to facilitate organization and selection of views at the user interface. For example, classes may group the views of a given store, a geographic location, or a “type” of view obtained by a camera (e.g., point of sale, front door, back door, storage room). Classes may overlap in the views included in each, and each view may belong to several classes.

The shift entry 430 defines a “shift,” which is a time period of interest to a manager, and can be used to define recorded video content for playback at the user interface. A shift may also be organized within a class, in which case an identifier or tag may be added to the respective shift or class entry. Each shift entry may include the following: A shift ID 432 holds a unique identifier for the shift, and may be coded to include a description of the shift. Tags 434A-C can be utilized to indicate various information about the respective shift, such as the view(s) obtained by the associated camera (e.g., point of sale, front door, back door, storage room), the time period of the shift, the geographic location(s) of the associated view(s), or the specific environment(s) (e.g., a given retail establishment) occupied by the camera(s). The tags 434A-C may also hold user-defined indicators, such as a bookmark or a frequently-accessed or “favorite” status. The camera ID(s) 436 hold the camera IDs of the one or more views associated with the shift. The time data 438 defines a time period of the shift, and is used to determine the start and end times of recorded video content to be retrieved for the shift. However, the final time boundaries of recorded video content to present to the user may deviate from the time data 438 due to motion data or other rules as described below. The shift rules 439 can define a number of conditions under which a notification is sent to a user, or conditions under which the time boundaries of the recorded video content may deviate from the time data 438. For example, for a given recorded video with start and stop times defined by the time data 438, the shift rules 439 may indicate to exclude some or all portions of the recorded video for which the camera did not detect motion. Conversely, the shift rules can indicate to include additional video content outside of the start and stop times (e.g., within a set time limit) when motion is detected by the camera outside of the start and stop times. Regarding notifications, the shift rules 439 may indicate to forward a notification to the user interface based on metadata or motion data. For example, a given shift may expect to detect no motion from the associated camera(s) during the given time period. If motion is detected, the shift rules 439 may indicate to raise a notification for review by the manager.

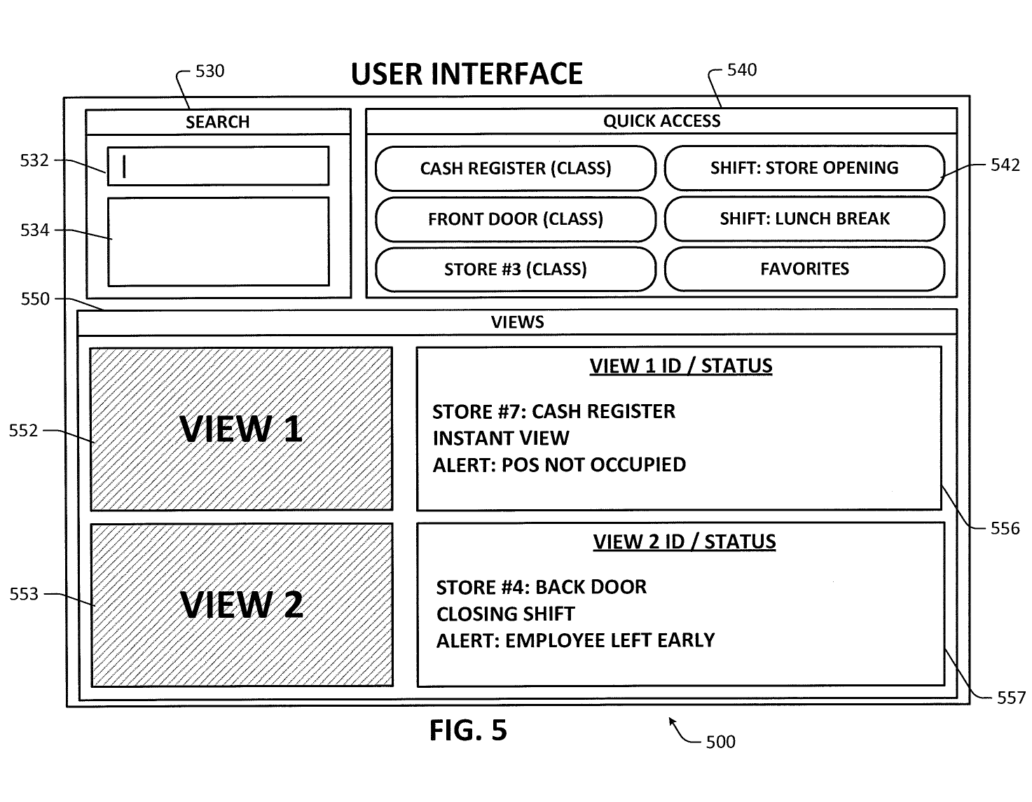

FIG. 5 is an illustration of a display (i.e., screen capture) 500 of a user interface provided by a cloud-based monitoring service in an example embodiment. The view 500 may illustrate, for example, a display of a user interface 64 described above with reference to FIGS. 1-4. The display 500 includes a search window 530, a quick access window 540, and a view window 550. During general use, a user enters input at the search window 530 and/or the quick access window 540, and the user interface displays corresponding views 552, 553 and corresponding statuses 556, 557 in response to the user's input. The search window 530 includes an input box 532, where the user may type a search string. The user may input a search string as natural language, or may input key words identifying the view(s) the user wishes to access. The input string may be received by the cloud computing server, where it is robustly interpreted to retrieve a selection of views and/or shifts. Specifically, the input string may be compared, along with its semantic equivalents, against the tags and other identifying indicators in the view, shift and class entries, and views corresponding to the matching entries may be displayed in the views window 550. In an example of searching by semantic equivalence, a search string of “cash register” may cause the server to search the entries for terms matching “cash register,” as well as terms having a defined semantic equivalence to this term, such as “point of sale” or “POS.” To facilitate selection, a results box 534 may list a number of tags, classes or other descriptors matching the search string or its semantic equivalents.

The quick access window 540 may contain a number of user-defined and/or automatically-selected buttons that can be selected to immediately display the associated selection of live or recorded video content. The buttons may be associated with a given tag or class (e.g., “cash register,” “front door,” “store #3”), or a given shift (e.g., “store opening,” “lunch break,” “store closing”), or may be a user-defined subset (e.g., “favorites,” “frequently-accesses”) having an associated tag.

The view window 550 displays corresponding views (or shifts) 552, 553 and corresponding statuses 556, 557 in response to the user's input. The statuses 556, 557 may display various information about the respective view or shift, including a description of the view (e.g., “Store #7: Cash Register,” “Store #4: Back Door”), the type of view (e.g., “Instant View,” “Closing Shift”), and any alerts or notifications associated with the view (e.g., “Alert: PUS not occupied,” “Alert: Employee left early”). Such alerts can be derived, for example, from motion data regarding the view (which may be generated by the cloud computing server, gateway or camera). When presenting a view or shift to a user, the cloud computing server may execute the rules contained is the respective view, shift or class entry to determine whether to forward an alert or other notification for display at the status 556, 557.

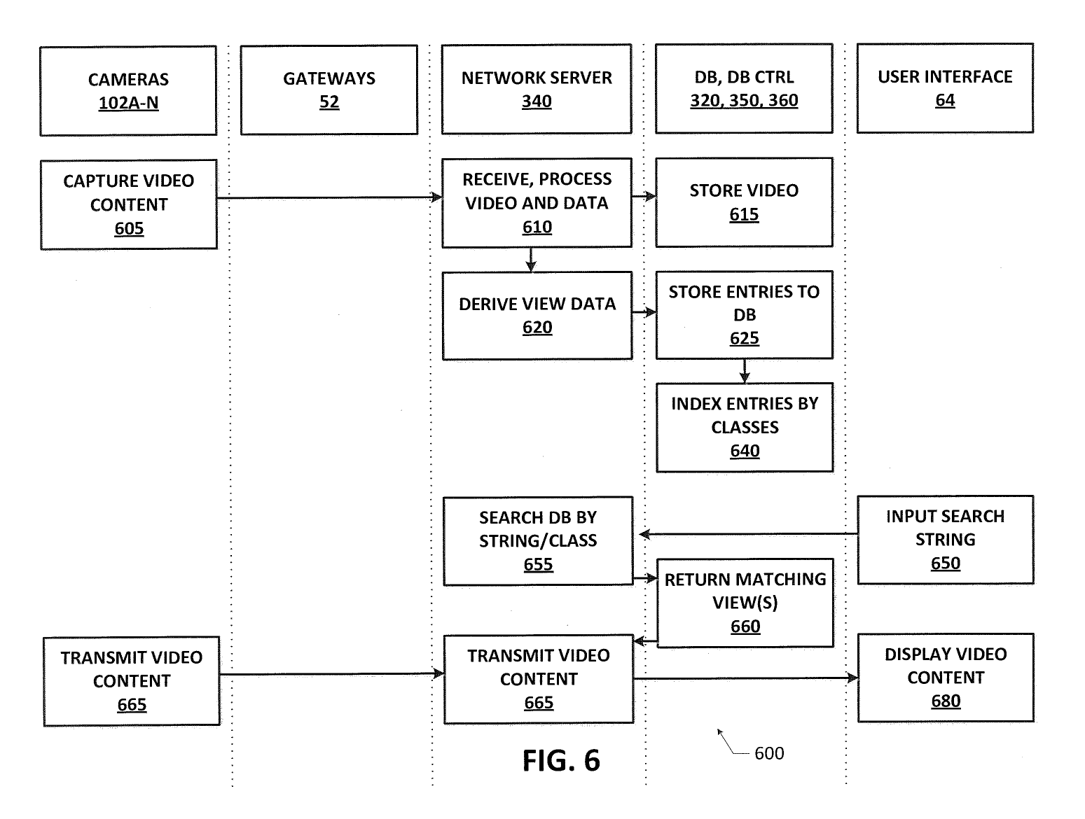

FIG. 6 is a flow diagram of a method 600 of managing views of a video surveillance network in one embodiment. The method is described with reference to the system 200 and cloud computing server 62 described above with reference to FIGS. 2-5. One method of establishing the database for view selection is as follows. The cameras 102A-N operate to capture video content continuously, periodically, or in response to a command from the gateway 52 or network server 439 (605). The video content may include metadata, such as a camera identifier and other information about the camera, and is transmitted to the network server 340, which receives and processes the video and metadata (610). The video content may be stored, in whole or in part, at the database 360 (615), and the network server 340 may further process the metadata to derive view data, including a camera identifier and information regarding the view captured by the camera (620). Alternatively, some or all of the view data may be entered manually on a per-camera basis. Using this view data, the network server 340 may store an entry corresponding to the view to the entry database 350 (625). The entry may be comparable to the view entry 420 described above with reference to FIG. 4, and the process (620, 625) may be repeated until each camera is associated with a view entry stored at the entry database 350. Further, the entries are indexed by one or more classes, each of which may have a class entry comparable to the entry 440 described above with reference to FIG. 4 (640). As indicated by the class entry, views may be added to the class based on listed tags (and their semantic equivalents) and other view information. The class entries may be pre-defined; alternatively, the network server 340 may be configured to generate class entries based on data received from the cameras 102A-N or gateways 52. For example, if the network server 340 detects several view entries having a common or similar tag that does not match a tag listed in a class entry, the network server may then add a class to the entry database 350 to group all entries having the given tag.

Once the database of view entries is established and indexed by class, a user may access one or more views by inputting a search string at a user interface 64 (650). The network server 340 receives the search string and searches the database 350 by matching the string against the class rules of each class entry (655). The network server 340 may perform an intermediate operation of interpreting the string according to a natural-language process to derive key words from the search string and their semantic equivalents, thereby performing the search using those results. The entry database 350 returns matching views (i.e., a selection of the entries) (660), from which the network server 340 identifies the one or more corresponding cameras (e.g., camera 102A). The network server 340 then causes video content from the corresponding cameras to be transmitted to the user interface 64 (665), which displays the video content (680). The video content may be transmitted directly from the cameras 102A-N to the user interface 64 via the gateways 52 as a result of the network server establishing an appropriate pipeline. Alternatively, the network server 340 may be configured to collect video content from the cameras 102A-N selectively and stream the live video content to the user interface 64 across the Iinternet 34.

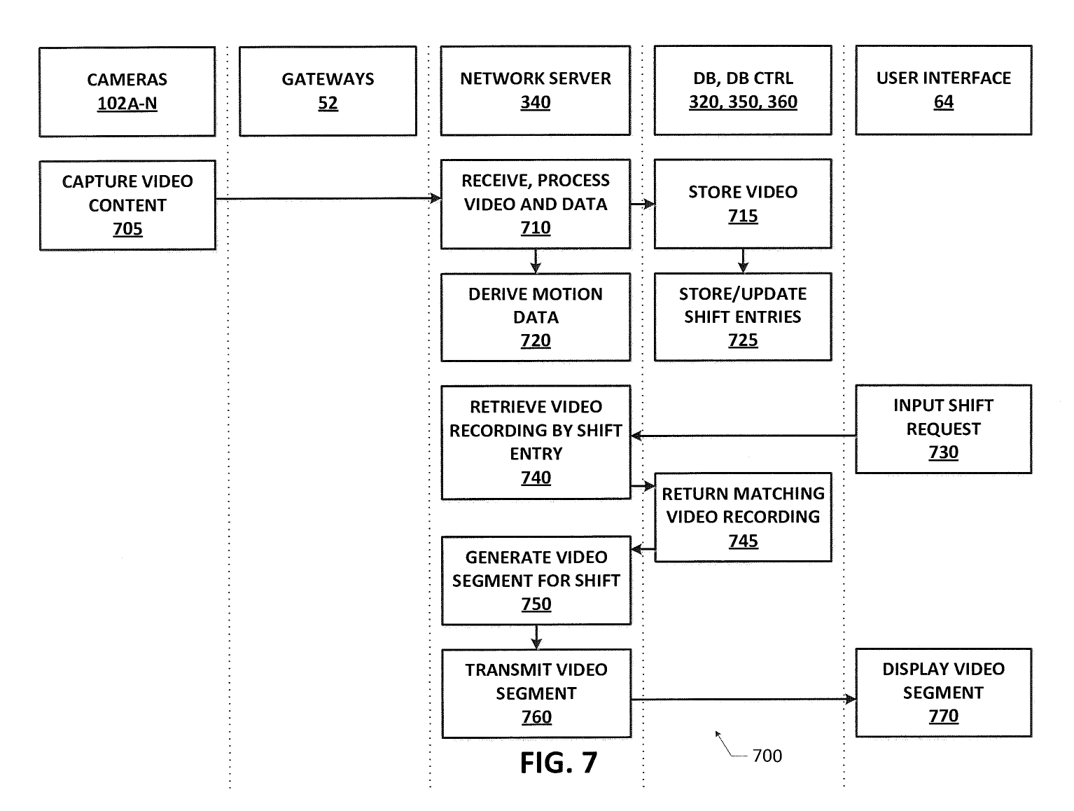

FIG. 7 is a flow diagram of a method 700 of managing recorded video shifts of a video surveillance network in one embodiment. The method is described with reference to the system 200 and cloud computing server 62 described above with reference to FIGS. 2-5. The method 700 may be performed in conjunction with the process 600 of managing views as described above with reference to FIG. 6. One method of establishing the database of recorded video shifts is as follows. The cameras 102A-N operate to capture video content continuously, periodically, or in response to a command from the gateway 52 or network server 439 (705). The video content may include metadata, such as a camera identifier and other information about the camera, and is transmitted to the network server 340, which receives and processes the video and metadata (710). The video content may be stored, in whole or in part, at the database 360 (715), and a determination of which portions of the video to store may be made based on shift entries stored at the entry database 350. In addition, the database controller 320 may update the shift entries, including storing a new shift entry, according to a user input (725). The shift entry may be comparable to the shift entry 430 described above with reference to FIG. 4. The network server 340 may further process the metadata from the video content to derive motion data (720). In alternative embodiments, the shift entries may be indexed by one or more classes, each of which may have a class entry comparable to the entry 440 described above with reference to FIG. 4. As indicated by the class entry, shifts may be added to the class based on listed tags (and their semantic equivalents) and other view information. The class entries may be pre-defined; alternatively, the network server 340 may be configured to generate class entries based on data received from the cameras 102A-N or gateways 52.

Once the database of shift entries is updated and associated recorded video is stored at the video database 360, a user may access one or more shifts by inputting a shift view request (730). The request may be formed by the user selecting the shift (via a “quick access” button) or by inputting a search string at a user interface 64. The network server 340 receives the request and retrieves a video recording from the video database matching the time and camera information indicated in the shift entry (740, 745). Using the time data from the shift entry and the motion data, the network server 340 generates a video segment for the requested shift (750). In particular, the network server may generate the video segment to have time boundaries with deviations from the time data of the shift entry, as determined from the shift rules and/or the motion data. For example, for a given recorded video with start and stop times defined by the time data, the shift rules of a shift entry may indicate to exclude some or all portions of the recorded video for which the camera did not detect motion. Conversely, the shift rules can indicate to include additional video content outside of the start and stop times (e.g., within a set time limit) when motion is detected by the camera outside of the start and stop times.

Once the video segment for a shift is produced, the network server 340 then causes the video segment to be transmitted to the user interface 64 (760), which displays the video segment (680).

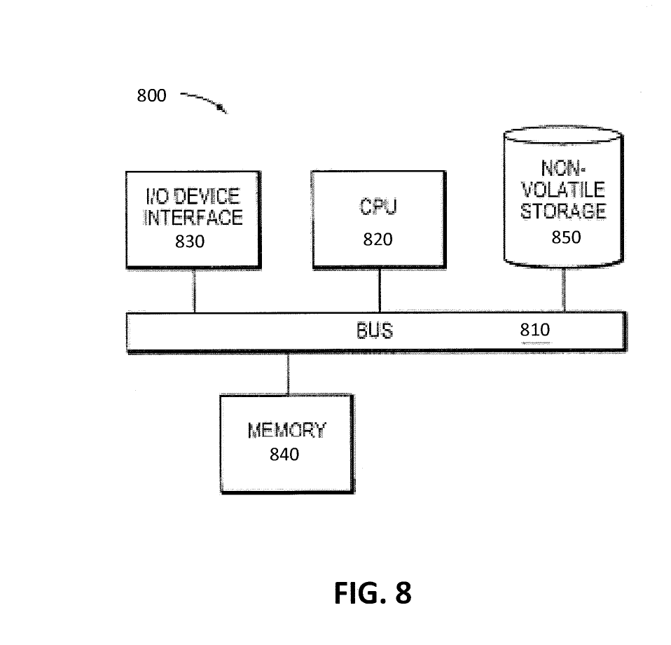

FIG. 8 is a high level block diagram of a computer system 800 in which embodiments of the present invention may be embodied. The system 800 contains a bus 810. The bus 810 is a connection between the various components of the system 800. Connected to the bus 810 is an input/output device interface 830 for connecting various input and output devices, such as a keyboard, mouse, display, speakers, etc. to the system 800. A Central Processing Unit (CPU) 820 is connected to the bus 810 and provides for the execution of computer instructions. Memory 840 provides volatile storage for data used for carrying out computer instructions. Disk storage 850 provides non-volatile storage for software instructions, such as an operating system (OS).

It should be understood that the example embodiments described above may be implemented in many different ways. In some instances, the various methods and machines described herein may each be implemented by a physical, virtual, or hybrid general purpose computer, such as the computer system 800. The computer system 800 may be transformed into the machines that execute the methods described above, for example, by loading software instruction into either memory 840 or non-volatile storage 850 for execution by the CPU 820. In particular, the cloud computing server described in various embodiments above may be implemented by the system 800.

Embodiments or aspects thereof may be implemented in the form of hardware, firmware, or software. If implemented in software the software may be stored on any non-transient computer readable medium that is configured to enable a processor to load the software or subsets of instructions thereof. The processor then executes the instructions and is configured to operate or cause an apparatus to operate in a manner as described herein.

While this invention has been particularly shown and described with references to example embodiments thereof, it will be understood by those skilled in the art that various changes in form and details may be made therein without departing from the scope of the invention encompassed by the appended claims.

What is claimed is:

1. A method of managing a video surveillance system, comprising:
storing a plurality of entries to a database, each entry corresponding to one of a plurality of cameras, each entry including a camera identifier and at least one tag;
indexing the database by at least one class, each of the plurality of entries being associated with the at least one class based on the at least one tag;
searching the database, based on a user input string and the at least one class, to determine a selection of the entries; and
causing video content to be transmitted to a user interface, the video content corresponding to at least one of the plurality of cameras corresponding to the selection of entries.

2. The method of claim 1, wherein at least a subset of the plurality of cameras are connected to distinct nodes of a network, and further comprising routing the video content to the user interface across the network.

3. The method of claim 1, wherein indexing the database includes associating at least one of the plurality of entries with the at least one class based on a semantic equivalence of the at least one tag.

4. The method of claim 1, further comprising automatically updating the at least one tag of the plurality of entries in response to a user operation.

5. The method of claim 4, wherein automatically updating the tags includes automatically adding a tag to at least one of the plurality of entries, the tag corresponding to a user input.

6. The method of claim 4, wherein the user operation includes at least one of the following: accessing a camera, viewing the video content, and selecting at least one camera.

7. The method of claim 1, further comprising automatically updating the at least one tag of the plurality of entries based on at least one of the camera identifier and a set of rules.

8. The method of claim 7, wherein updating the at least one tag includes adding a tag to at least one of the plurality of entries, the tag indicating a view obtained by a respective camera.

9. The method of claim 7, wherein updating the at least one tag includes modifying the at least one tag to a semantically equivalent tag.

10. The method of claim 1, further comprising generating at least one semantic equivalent to at least a portion of the user input string, and wherein searching the database is based on the at least one semantic equivalent.

11. The method of claim 1, wherein the at least one tag indicates a view obtained by the one of the plurality of cameras.

12. The method of claim 1, wherein the at least one class includes at least a first and a second class, the first class indicating a view obtained by a camera, the second class indicating a geographic location of a camera.

13. The method of claim 1, further comprising generating the at least one class based on the at least one tag.

14. A system for managing a video surveillance system, comprising:
a database storing a plurality of entries, each entry corresponding to one of a plurality of cameras, each entry including a camera identifier and at least one tag;
a database controller configured to 1) index the database by at least one class, each of the plurality of entries being associated with the at least one class based on the at least one tag, and 2) search the database, based on a user input string and the at least one class, to determine a selection of the entries; and
a network server configured to cause video content to be transmitted to a user interface, the video content corresponding to at least one of the plurality of cameras corresponding to the selection of entries.

15. The system of claim 14, wherein at least a subset of the plurality of cameras are connected to distinct nodes of a network, further comprising at least one gateway configured to route the video content to the user interface across the network.

16. The system of claim 14, wherein the database controller is further configured to associate at least one of the plurality of entries with the at least one class based on a semantic equivalence of the at least one tag.

17. The system of claim 14, wherein the database controller is further configured to update automatically the at least one tag of the plurality of entries in response to a user operation.

18. The system of claim 17, wherein updating the tags includes automatically adding a tag to at least one of the plurality of entries, the tag corresponding to a user input.

19. The system of claim 17, wherein the user operation includes at least one of the following: accessing a camera, viewing the video content, and selecting at least one camera.

20. The system of claim 14, wherein the database controller is further configured to update automatically the at least one tag of the plurality of entries based on at least one of the camera identifier and a set of rules.

21. The system of claim 20, wherein updating the at least one tag includes adding a tag to at least one of the plurality of entries, the tag indicating a view obtained by a respective camera.

22. The system of claim 20, wherein updating the at least one tag includes modifying the at least one tag to a semantically equivalent tag.

23. The system of claim 14, wherein the database controller is further configured to generate at least one semantic equivalent to at least a portion of the user input string, and wherein filtering the database is based on the at least one semantic equivalent.

24. The system of claim 14, wherein the at least one tag indicates a view obtained by the one of the plurality of cameras.

25. The system of claim 14, wherein the at least one class includes at least a first and a second class, the first class indicating a view obtained by a camera, the second class indicating a geographic location of a camera.

26. The system of claim 14, wherein the database controller is further configured to generate the at least one class based on the at least one tag.

27. A non-transitory computer-readable medium comprising instructions that, when executed by a computer, cause the computer to:
store a plurality of entries to a database, each entry corresponding to one of a plurality of cameras, each entry including a camera identifier and at least one tag;
index the database by at least one class, each of the plurality of entries being associated with the at least one class based on the at least one tag;
search the database, based on a user input string and the at least one class, to determine a selection of the entries; and
cause video content to be transmitted to a user interface, the video content corresponding to at least one of the plurality of cameras corresponding to the selection of entries.
